(19) United States
(12) Patent Application Publication
(10) Pub. No.: US 2019/0057399 A1
(43) Pub. Date: Feb. 21, 2019

(54) IDENTIFYING WHETHER AN OBJECTIVE INCLUDED IN A CONTENT ITEM PRESENTED BY AN ONLINE SYSTEM WAS PERFORMED WITHOUT THE ONLINE SYSTEM RECEIVING INFORMATION FROM A CLIENT DEVICE IDENTIFYING A USER

(71) Applicant: Facebook, Inc., Menlo Park, CA (US)

(72) Inventors: Li Zhou, Campbell, CA (US); Liang Xu, Bellevue, WA (US)

(21) Appl. No.: 15/677,013

(22) Filed: Aug. 15, 2017

(51) Int. Cl. G06Q 30/02; G06Q 50/00; G06N 99/00

(52) U.S. Cl. CPC G06Q 30/0201; G06N 99/005; G06Q 50/01

(57) ABSTRACT

An online system provides content items to client devices for presentation to users and receives information describing actions by users performed by users via the client devices. Certain client devices withhold information uniquely identifying the client devices from the online system to prevent the online system from subsequently identifying a particular user from information uniquely identifying the client device. When the online system receives a description of an action from such a client device that matches an objective included in a content item presented by the online system, the online system identifies users to whom the content item was presented and who are associated with client device characteristics matching characteristics received from the client device. A model is applied by the online system to the identified users that determines a likelihood that at least one of the identified users to whom the content item was presented performed the action.

### BACKGROUND

This disclosure relates generally to presenting content to online system users, and more specifically to determining whether a user performed a particular action after being presented with a content item.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. Content provided to an online system by a user may be declarative information provided by a user, status updates, check-ins to locations, images, photographs, videos, text data, or any other information a user wishes to share with additional users of the online system. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

To determine whether a user presented with a content item performed an action after being presented with the content item, the online system receives information from a client device associated with the user. The information identifies one or more actions performed by the user via the online system and also includes characteristics of the client device. A client device may include a device identifier or other information uniquely identifying the client device to the online system along with the information identifying the one or more actions performed by the user. The online system compares information uniquely identifying the client device to information associated with various users to identify a user corresponding to the client device and to determine whether the user was presented with a content item having an objective satisfied by an action identified by information received from the client device. This allows the online system to determine whether to request compensation form a publishing user associated with a content item presented to the identified user and including an objective satisfied by the user's actions. However, certain client devices are configured to prevent communication of information uniquely identifying the client devices to the online system. While client devices with such a configuration may provide the online system with information describing actions performed by users, as well as information describing characteristics of the client devices that do not uniquely identify particular client devices, conventional online systems are unable to identify a particular user from information received from a client device with such a configuration. This prevents the online system from determining whether a user of a client device that does not provide the online system with information uniquely identifying the client device performed an action satisfying an objective included in a content item presented to the user, which may prevent the online system from obtaining compensation from a publishing user associated with the content item.

### SUMMARY

Various users provide content to an online system for presentation to other users, allowing a user to leverage information maintained by the online system to distribute content to other users. A publishing user provides a content item to the online system for presentation to other users and compensates the online system when users to whom the online system presented the content item perform specific actions after being presented with the content item. The online system obtains information describing interactions (or actions) by users with the presented content items or after being presented with the content items and associates described interactions or actions with users who performed the interactions or actions and with the content items.

To encourage online system users to perform a particular action, the publishing user provides content item to the online system that includes an objective specifying a desired action by users to whom the content item is presented. Example objectives include: installing an application associated with the content item, indicating a preference for the content item, sharing the content item with other users, interacting with the object associated with a content item, making a purchase through an application associated with the content item, or performing any other suitable interaction. Additionally, the content item includes a bid amount specifying an amount of compensation a publishing user associated with the content item provides the online system in response to an online system user performing the action specified by the objective after being presented with the content item.

When the online system presents the content item to a user, the online system communicates the content item to a client device associated with the user for presentation. However, various client devices may be configured to withhold device identifiers associated with the client devices, or other information uniquely identifying the client devices, from the online system. Such a configuration of a client device prevents the online system from identifying the particular client device from which the online system receives information describing actions performed via the client device. As the online system may use a device identifier corresponding to a client device to identify a user associated with the client device and associate an action identified by the client device with the user associated with the client device, withholding the device identifier associated with the client device prevents the online system from identifying a user who performed an action via the client device. While this increases a user's privacy, withholding a device identifier of the client device from the online system prevents the online system from determining whether the user to whom the content item was presented. Without identifying whether a user to whom the content item was presented performed the action specified in the objective of the content item, the online system is unable to determine whether to request compensation from the publishing user from the user performing the action specified in the content item's objective.

To determine whether the user to whom the content item was presented via a client device withholding a device identifier of the client device from the online system, when the online system receives information from the client device identifying the action satisfying the objective included in the content item and characteristics of the client device, the online system identifies users to whom the content item was presented by the online system. While the client device withholds the device identifier, when the user performs the action satisfying the objective included in the content item, the client device communicates a description of the performed action satisfying the objective to the online system along with characteristics of the client device to the online system. However, the characteristics of the client device received by the online system do not include information uniquely identifying the client device to the online system. For example, characteristics of the client device includes a network address (such as an Internet Protocol address) used by the client device to communicate with a network. Other example characteristics of the client device received by the online system include an identifier of an application executing on the client device from which the user performed the action satisfying the objective of the content item, a type of the client device (e.g., a manufacturer, an identifier of a model of the client device 110, etc.), and an operating system executing on the client device.

Based on information maintained by the online system describing presentation of content items to various users, the online system identifies users to whom the content item was presented. Using the received characteristics of the client device and information maintained by the online system for each of the identified users, the online system selects a set of the identified users for whom the online system maintains information matching the received characteristics of the client device. In various embodiments, the online system includes characteristics of client devices associated with various users in user profiles maintained for the users. Therefore, the online system compares the received characteristics of the client device to user profiles maintained for various identified users and selects identified users associated with user profiles including characteristics of client devices matching the received characteristics. For example, the online system selects a set of identified users each associated with user profiles including characteristics of a client device matching each of the received characteristics of the client device. Hence, the set of identified users includes users who were presented with the content item and for whom the online system has associated characteristics of a client device that match the received characteristics.

The online system applies a model to characteristics of users of the set of identified users that determines a likelihood that at least one user of the set performed the action satisfying the objective of the content item for which the online system received information from the client device. In various embodiments, the model is trained based on characteristics associated with other users who previously performed the action satisfying the objective of the content item after being presented with the content item. Application of the model to the selected set of identified users determines the likelihood that at least one user of the set performed the action satisfying the objective of the content item and identified by the information received from the client device; however, the model does not identify whether a particular user of the set performed the action satisfying the objective of the content item.

In response to the likelihood of at least one user of the set of identified users equaling or exceeding a threshold, the online system stores an indication the desired user was performed by at least one user of the set of the identified user in response to the determined likelihood equaling or exceeding a threshold. This allows the online system to identify that an action satisfying the objective of the content item was performed after the content item was presented to the user, even though the online system is unable to identify the user who performed the action satisfying the objective of the content item from the information received from the client device. As the online system receives compensation from the publishing user associated with the content item when a user presented with the content item performs an action satisfying the objective of the content item after being presented with the content item, if the likelihood of at least one user of the set of identified users equals or exceeds the threshold, the online system requests compensation from the publishing user associated with the content item. Hence, while unable to identify the particular user who performed the action satisfying the objective of the content item, the online system leverages information associated with users and received characteristics of the client device to determine whether presentation of the content item via a client device that does not provide a device identifier (or other uniquely identifying information) to the client device was followed by performance of the action satisfying the objective of the client device on a client device having characteristics matching the received characteristics.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for an online system to determine whether an action performed by a user identified by a client device was performed after a content item having an objective of the action was presented to a user by a client device having characteristics matching characteristics of the client device, in accordance with an embodiment.

FIG. 4 is a process flow diagram of an online system determining whether an action performed by a user identified by a client device was performed after a content item having an objective of the action was presented to a user by a client device having characteristics matching characteristics of the client device, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

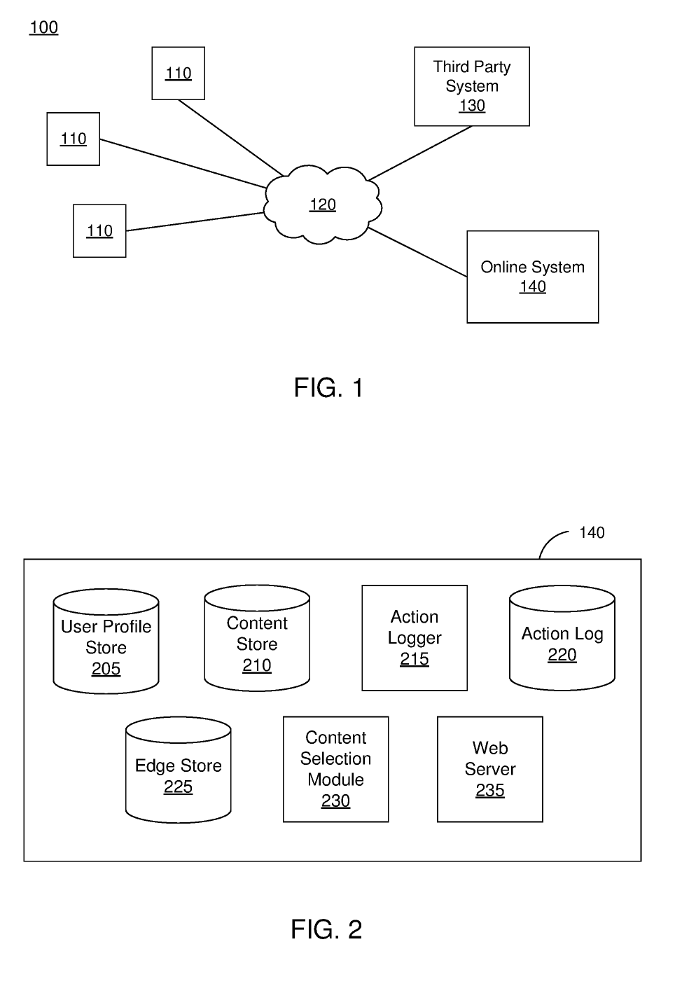

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

Additionally, a user profile maintained for a user includes characteristics of one or more client devices 110 associated with the user, allowing the online system 140 to subsequently identify the user from characteristics provided by a client device 110. For example, an application associated with the online system 140 and executing on a client device 110 provides a device identifier or other information uniquely identifying the client device 110 to the online system 140 in association with a user identifier. The online system 140 stores the device identifier or other information uniquely identifying the client device 110 in the user profile maintained for the user, allowing subsequent identification of the user if the online system 140 receives the device identifier or other information uniquely identifying the client device 110. Other characteristics of client devices 110 associated with the user may be alternatively or additionally included in the user profile maintained by the user. For example, the user profile includes a network address used by a client device 110 to access a network 120, an identifier of an application executing on a client device 110 from which the online system 140 received information, a type of the client device 110 (e.g., a manufacturer, an identifier of a model of the client device 110, etc.) from which the online system 140 received information, and an operating system executing on the client device 110 from which the online system 140 received information. However, the online system 140 may store any suitable characteristics of a client device 110 in a user profile, allowing the online system 140 to maintain information about client devices 110 used by the user corresponding to the user profile.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include a creative, which is content for presentation to a user, and a bid amount. The creative is text, image, audio, video, or any other suitable data presented to a user. In various embodiments, the creative also specifies a page of content. For example, a content item includes a link that specifying a network address of a landing page of content to which a user is directed when the content item is accessed. If a user presented with the content. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on attributes associated with the user by the online system 140 and based on the user's affinity for different content items. A measure of relevance of a content item to the user is based on a measure of quality of the content item for the user, which may be based on the creative included in the content item as well as content of a landing page identified by a link in the content item. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with content items when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the content item's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed includes content items such as stories describing actions associated with other online system users connected to the user. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a feed including a plurality of content items selected for presentation to the user. The content selection module 230 may also determine the order in which selected content items are presented via the feed. For example, the content selection module 230 orders content items in the feed based on likelihoods of the user interacting with various content items.

Additionally, when a content item presented to a user by the content selection module 230 includes a bid amount, the content selection module 230 requests compensation from a publishing user associated with the content item after the content item is presented or after a user performs an action satisfying an objective included in the content item after being presented with the content item. For example, after a content item including an objective is presented to a user via a client device 110, the action logger 215 receives information from the client device 110 including a device identifier of the client device 110 and a description of an action performed via the client device. The action logger 215 compares the device identifier to device identifiers included in user profiles maintained in the user profile store 205, identifies a user associated with a user profile including the received device identifier, and stores information in the action log 220 identifying the user, the action, a time when the action occurred, and the content item. The content selection module 230 compares the action associated with the user and with the content item in the action log 220 to the objective included in the content item and requests compensation from the publishing user if the content selection module 230 presented the content item to the user and the action associated with the user and with the content item occurred after the content item was presented to the user and satisfies the objective of the content item.

However, certain client devices 110 are configured to withhold information uniquely identifying the client devices 110, such as device identifiers. While these client devices 110 communicate information to the online system 140 when an online system user performs an action via the client devices 110, the information received by the online system 140 does not allow the online system 140 to particularly identify a client device 110. Hence, the action logger 215 and content selection module 230 are unable to identify a specific user who performed the action via the client device 110.

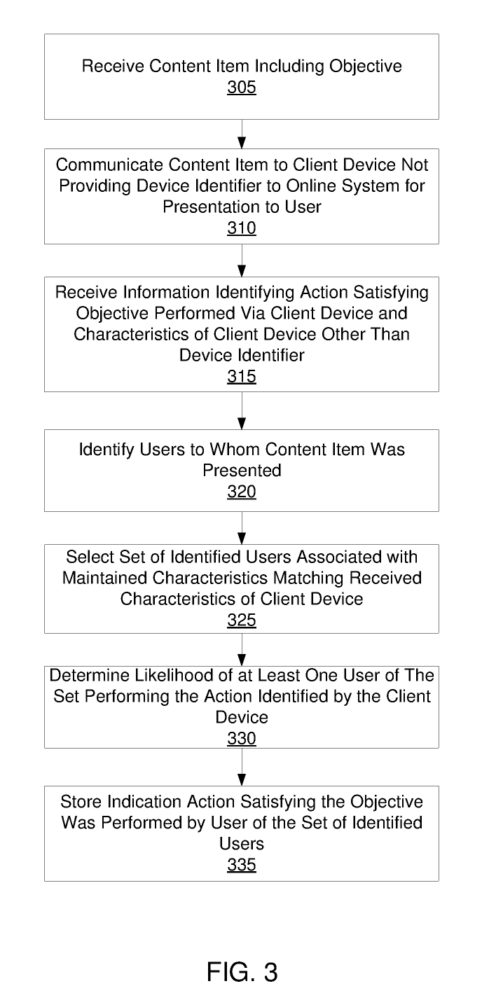

To determine whether an action satisfying an objective of a content item and identified by a client device 110 that does not provide information uniquely identifying the client device 110 was performed by a user to whom the content item was presented, the content selection module 230 retrieves information from the action log 220 or maintained by the content selection module 230 and identifies users to whom the content item was presented. As further described below in conjunction with FIG. 3, the content selection module 230 retrieves user profiles maintained for the identified users from the user profile store 205 and selects a set of users associated with user profiles including client device characteristics matching characteristics received from the client device 110 that identified the action satisfying the objective of the content item. For example, each user of the set is associated with a user profile that includes client device characteristics matching each of the characteristics received from the client device 110. The content selection module 230 applies a model to characteristics of users of the set that determines a likelihood of at least one user of the set having performed the action identified by the client device 110, as further described below in conjunction with FIG. 3. If the determined likelihood equals or exceeds a threshold, the content selection module 230 determines the action satisfying the objective of the content item identified by the client device 110 that did not provide uniquely identifying information was performed by a user to whom the content item was presented. Accordingly, the content selection module 230 requests compensation from the publishing user who provided the content item.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

### Determining a Likelihood of an Action Identified by a Client Device was Performed by an Online System User to Whom a Content Item was Presented

FIG. 3 is a flowchart of one embodiment of a method for an online system 140 to determine whether an action performed by a user identified by a client device 110 was performed by a user to whom a content item having an objective of the action was presented. In various embodiments, the steps described in conjunction with FIG. 3 may be performed in different orders. Additionally, in some embodiments, the method may include different and/or additional steps than those shown in FIG. 3.

The online system 140 receives 305 a content item for presentation to users of the online system 140 that includes an objective specifying a desired actions by users to whom the content item is presented. Example objectives include: installing an application associated with the content item, indicating a preference for the content item, sharing the content item with other users, interacting with the object associated with a content item, making a purchase through an application associated with the content item, or performing any other suitable interaction. Additionally, the content item includes a bid amount specifying an amount of compensation a publishing user associated with the content item provides the online system 140 in response to an online system user performing the action specified by the objective after being presented with the content item. This allows the publishing user to leverage the online system 140 to increase a number of users who may perform the objective included in the content item and allows the online system 140 to receive compensation from the publishing user in exchange for presenting the content item.

As further described above in conjunction with FIG. 2, the online system 140 selects content for presentation to a user. When the selected content includes the content item, the online system 140 communicates 310 the content item to a client device 110 associated with the user for presentation. However, various client devices 110 may be configured to withhold device identifiers associated with the client devices 110 from the online system 140. Such a configuration prevents the online system 140 from identifying particular client devices 110 from which the online system 140 receives information describing actions performed via the client devices 110. As the online system 140 may use a device identifier corresponding to a client device 110 to identify a user associated with the client device 110 and associate an action identified by the client device 110 with the user associated with the client device 110, withholding the device identifier associated with the client device 110 prevents the online system 140 from identifying a user who performed an action via the client device 110. While this increases a user's privacy, withholding a device identifier of the client device 110 from the online system 140 prevents the online system 140 from determining whether the user to whom the content item was presented. Without identifying whether a user to whom the content item was presented performed the action specified in the objective of the content item, the online system 140 is unable to determine whether to request compensation from the publishing user from the user performing the action specified in the content item's objective.

Hence, to determine whether the user to whom the content item was presented via the client device 110 withholding a device identifier of the client device from the online system 140, when the online system 140 receives 315 information from the client device 110 identifying the action satisfying the objective included in the content item and characteristics of the client device 110, the online system 140 identifies 320 users to whom the content item was presented by the online system 140. While the client device 110 withholds the device identifier, when the user performs the action satisfying the objective included in the content item, the client device 110 communicates a description of the performed action satisfying the objective to the online system 140 along with characteristics of the client device 110. However, the characteristics of the client device 110 received 315 by the online system 140 do not include information uniquely identifying the client device 110 to the online system 140. For example, characteristics of the client device 110 includes a network address (such as an Internet Protocol address) used by the client device 110 to communicate with a network 120. Other example characteristics of the client device 110 received 315 by the online system 140 include an identifier of an application executing on the client device 110 from which the user performed the action satisfying the objective of the content item, a type of the client device 110 (e.g., a manufacturer, an identifier of a model of the client device 110, etc.), and an operating system executing on the client device 110. However, in various embodiments, the client device 110 may provide any suitable characteristics or combination of characteristics of the client device 110 that do not include information uniquely identifying the client device 110 to the online system 140.

Based on information maintained by the online system 140 describing presentation of content items to various users, the online system 140 identifies 320 users to whom the content item was presented. In various embodiments, the online system 140 identifies 320 users who were presented with the content item within a threshold amount of time from a time when the online system 140 received 315 the information identifying the action satisfying the objective included in the content item and the characteristics of the client device 110. For example, the online system 140 identifies 320 users to whom the content item was presented during a time interval from a time when the online system 140 received 305 the content item and the time when the online system 140 received 315 the information identifying the action satisfying the objective included in the content item and the characteristics of the client device 110.

Based on the received characteristics of the client device 110 and information maintained by the online system 140 for each of the identified users, the online system 140 selects 325 a set of the identified users for whom the online system 140 maintains information matching the received characteristics of the client device 110. In various embodiments, the online system 140 includes characteristics of client devices 110 associated with various users in user profiles maintained for the users. Therefore, the online system 140 compares the received characteristics of the client device 110 to user profiles maintained for various identified users and selects 325 identified users associated with user profiles including characteristics of client devices 110 matching the received characteristics. For example, the online system 140 selects 325 a set of identified users each associated with user profiles including characteristics of a client device 110 matching each of the received characteristics of the client device 110. Hence, the set of identified users includes users who were presented with the content item and for whom the online system 140 has associated characteristics of a client device 110 that match the received characteristics.

The online system 140 applies a model to characteristics of users of the set of identified users that determines 330 a likelihood that at least one user of the set performed the action satisfying the objective of the content item for which the online system 140 received 315 information from the client device 110. In various embodiments, the model is trained based on characteristics associated with other users who previously performed the action satisfying the objective of the content item after being presented with the content item. For example, the online system 140 trains the model based on characteristics of users the online system 140 was previously capable of identifying from device identifiers received from client devices 110 associated with the users along with information indicating the users performed the action satisfying the objective of the content item. Alternatively, the online system 140 trains the model based on characteristics associated with other users who previously performed the action satisfying the objective of the content item after being presented with other content items having at least a threshold amount of characteristics matching characteristics of the content item. Application of the model to the selected set of identified users determines 330 the likelihood that at least one user of the set performed the action satisfying the objective of the content item and identified by the information received 315 from the client device 110; however, the model does not identify whether a particular user of the set performed the action satisfying the objective of the content item.

In some embodiments, the online system 140 determines a number of identified users of the set and determines 330 the likelihood that at least one user of the set performed the action satisfying the objective of the content item in response to the number of identified users of the set being less than a threshold number. However, if the number of identified users of the set exceeding the threshold number, the online system 140 does not apply the model to the set of identified users. Accordingly, the online system 140 may not determine the likelihood of at least one user of the set performing the action satisfying the objective of the content item if the set includes greater than the threshold number of users.

In response to the likelihood of at least one user of the set of identified users equaling or exceeding a threshold, the online system 140 stores 335 an indication the desired user was performed by at least one user of the set of the identified user in response to the determined likelihood equaling or exceeding a threshold. This allows the online system 140 to identify that an action satisfying the objective of the content item was performed after the content item was presented to the user, even though the online system 140 is unable to identify the user who performed the action satisfying the objective of the content item from the information received 315 from the client device 110. As the online system 140 receives compensation from the publishing user associated with the content item when a user presented with the content item performs an action satisfying the objective of the content item after being presented with the content item, if the likelihood of at least one user of the set of identified users equals or exceeds the threshold, the online system 140 requests compensation from the publishing user associated with the content item. Hence, while unable to identify the particular user who performed the action satisfying the objective of the content item, the online system 140 leverages information associated with users and received characteristics of the client device 110 to determine whether presentation of the content item via a client device 110 that does not provide a device identifier (or other uniquely identifying information) to the client device 110 was followed by performance of the action satisfying the objective of the client device 110 on a client device 110 having characteristics matching the received characteristics.

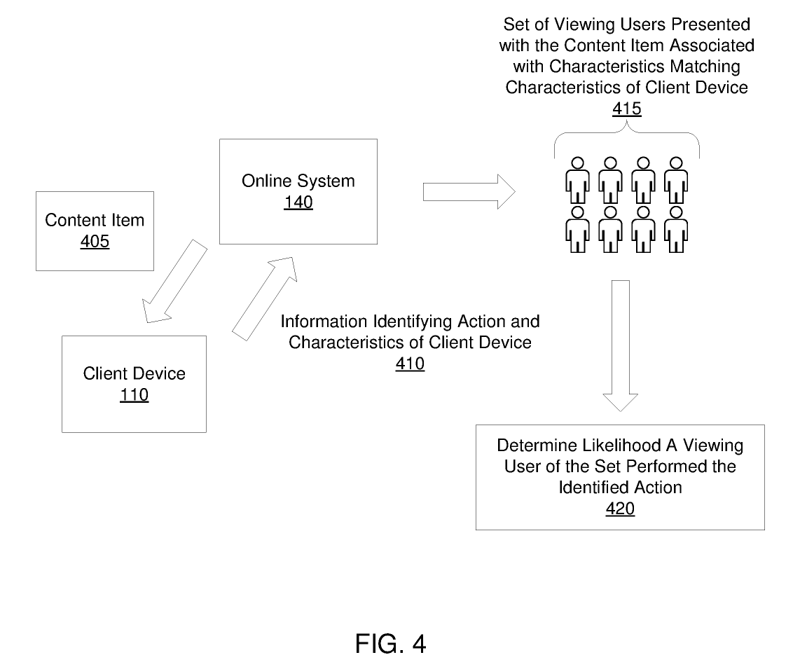

FIG. 4 is a process flow diagram of an online system 140 determining whether an action performed by a user identified by a client device 110 was performed after a content item having an objective of the action was presented to a user by a client device 110 having characteristics matching characteristics of the client device 110. In the example of FIG. 4, the online system 140 provides a content item 405 to a client device 110 for presentation to a user. As further described above in conjunction with FIGS. 2 and 3, the content item 405 includes an objective specifying a desired action for a user to perform after being presented with the content item 405.

The client device 110 communicates information describing an action performed by the user via the client device 110 that satisfies the objective of the content item 405. However, the client device 110 does not communicate information uniquely identifying the client device 110 to the online system 140, which prevents the online system 140 from identifying the user who performed the action via the online system 140. This prevents the online system 140 from determining that the user who performed the action satisfying the objective of the content item 405 was a user who was presented with the content item 405.

However, the client device 110 communicates characteristics 410 of the client device 110 to the online system 140. The characteristics 410 communicated by the client device 110 do not allow the online system 140 to uniquely identify the client device 110, but provide information about the client device 110 to the online system 140. To determine whether the user who performed the action satisfying the objective of the content item 405 was a user who was presented with the content item 405, the online system 140 compares the characteristics 410 of the client device 110 to information maintained by the online system 140 to identify a set 415 of viewing users who were presented with the content item 405. As further described above in conjunction with FIG. 3, the online system 140 identifies viewing users to whom the content item 405 was presented based on information the online system 140 associates with users and identifies the set 415 of viewing users as viewing users associated with information maintained by the online system 140 specifying characteristics of a client device 110 matching the characteristics 410 received from the client device 110. Hence, the set 415 of viewing users includes users who were presented with the content item 405 and who are associated with a client device 110 having characteristics matching the characteristics 410 received from the client device 110.

As further described above in conjunction with FIG. 3, the online system 140 applies a model to characteristics of viewing users of the set 415 that determines 420 a likelihood that at least one viewing user of the set performed the action identified by the client device 110. The determined likelihood does not identify a specific user who performed the action identified by the client device 110, but instead specifies a likelihood that a viewing user presented with the content item 405 and associated with characteristics of a client device 110 matching the characteristics 410 received from the client device 110 performed the action. If the determined likelihood equals or exceeds a threshold, the online system 140 determines that the action identified by the client device 110 and satisfying the objective of the content item 405 was performed by a user who was presented with the content item 405. Accordingly, the online system 140 may request compensation from a publishing user associated with the content item 405 for presentation of the content item 405 to the user.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a content item at an online system for presentation to users of the online system, the content item including an objective specifying a desired action by users to whom the content item is presented;
communicating the content item to a client device associated with a user of the online system for presentation, the client device configured to withhold an identifier of the client device from the online system;
receiving, at the online system, information from the client device identifying the desired action and characteristics of the client device;
identifying users of the online system to whom the content item was presented;
selecting a set of the identified users for whom the online system has associated information matching the received characteristics of the client device;
determining a likelihood that at least one user of the set of the identified users performed the desired action by applying a model to characteristics of users of the set of the identified users; and
storing, at the online system, an indication the desired action was performed by at least one user of the set of the identified user in response to the determined likelihood equaling or exceeding a threshold.

2. The method of claim 1, wherein the content item further includes a bid amount specifying an amount of compensation a publishing user associated with the content item provides the online system in response to the desired action being performed after presentation of the content item.

3. The method of claim 2, further comprising:
requesting compensation from the publishing user in response to the determined likelihood equaling or exceeding a threshold.

4. The method of claim 1, wherein a characteristic of the client device comprises a network address of the client device.

5. The method of claim 4, wherein characteristics of the client device further include one or more selected from a group consisting of: an identifier of an application from which the desired action was performed, a type of the client device, an operating system executing on the client device, and any combination thereof.

6. The method of claim 1, wherein selecting the set of the identified users for whom the online system has associated information matching the received characteristics of the client device comprises:
selecting identified users for whom the online system associates information matching each of the received characteristics of the client device.

7. The method of claim 1, wherein determining the likelihood that at least one user of the set of the identified users performed the desired action by applying the model to characteristics of users of the set of the identified users comprises:
determining a number of identified users in the set of the identified users; and
determining the likelihood that at least one user of the set of the identified users performed the desired action in response to the number of identified users in the set of the identified users being less than a threshold number.

8. The method of claim 7, wherein determining the likelihood that at least one user of the set of the identified users performed the desired action by applying the model to characteristics of users of the set of the identified users further comprises:
withholding determination of the likelihood that at least one user of the set of the identified users performed the desired action in response to the number of identified users in the set of the identified users being greater than the threshold number.

9. The method of claim 1, wherein the model applied to characteristics of users of the set of the identified users comprises a model trained on characteristics associated with other users who previously performed the desired action after being presented with the content item.

10. The method of claim 1, wherein the model applied to characteristics of users of the set of the identified users comprises a model trained on characteristics associated with other users who previously performed the desired action after being presented with one or more content items having at least a threshold amount of characteristics matching characteristics of the content item.

11. A computer program product comprising a non-transitory computer readable medium having instructions encoded thereon that, when executed by a processor, cause the processor to:
maintain an embedding corresponding to each user of an online system, the embedding corresponding to a user based on interactions by the user with content presented to the user by the online system;
obtain a content item at an online system for presentation to users of the online system;
present content from the content item to viewing users of the online system;
identify a set of viewing users to whom the content item was presented who performed one or more specific actions with the content item;
generate a content embedding associated with the content item based on embeddings corresponding to each of the set of viewing users;
identify a candidate user of the online system;
retrieve an embedding corresponding to the candidate user of the online system;
determine a similarity of the embedding corresponding to the candidate user of the online system and the content embedding; and
communicate a recommendation for the content item to a client device associated with the candidate user in response to the similarity equaling or exceeding a threshold.

12. The computer program product of claim 11, wherein the embedding corresponding to the user includes one or more dimensions that each have a value based on a number of times the user performed an interaction corresponding to a dimension.

13. The computer program product of claim 12, wherein determine the similarity of the embedding corresponding to the candidate user of the online system and the content embedding comprises:
determine a measure of similarity between the embedding corresponding to the candidate user of the online system and the content embedding based on values of one or more dimensions of the embedding corresponding to the candidate user and values of one or more dimensions of the content embedding.

14. The computer program product of claim 12, wherein generate the content embedding associated with the content item based on embeddings corresponding to each of the set of viewing users
determine values associated with one or more dimensions of each embedding corresponding to a viewing user of the set;
determine weights associated with one or more dimensions of each embedding maintained for the viewing users of the set; and
generate the content embedding based on the determined values and the determined weights.

15. The computer program product of claim 11, wherein the content item includes video data.

16. The computer program product of claim 15, wherein the video data is presented to one or more users of the online system as the online system receives the video data.

17. The computer program product of claim 15, wherein a specific action with the content item comprises viewing a threshold amount of the video data included in the content item.

18. The computer program product of claim 15, wherein a specific action with the content item comprises: indicating a reaction to at least a portion of the video data, sharing the video data with another user, commenting on the video data, stopping the video data, closing the video data, navigating away from the video data, identifying a complaint with the video data, or any combination thereof.

19. The computer program product of claim 15, wherein identify the set of viewing users to whom the content item was presented who performed one or more specific actions with the content item comprises:
identify a set of users who are currently viewing the video data included in the content item and who have viewed at least a threshold amount of the video data.

20. The computer program product of claim 11, wherein the computer readable storage medium further has instructions encoded thereon that, when executed by the processor, cause the processor to:
determine a number of users presented with the content item who performed one or more interactions with the content item; and
store the content embedding in association with the content item in response to the determined number of users equaling or exceeding a threshold number of users.
